(19) United States
(12) Patent Application Publication
(10) Pub. No.: US 2024/0376231 A1
(43) Pub. Date: Nov. 14, 2024

(54) METHODS OF EXTRACTING CORN FIBER GUM AND USES IN EMULSION AND ENCAPSULATION

(71) Applicant: Kansas State University Research Foundation, Manhattan, KS (US)

(72) Inventor: Yong-Cheng Shi, Manhattan, KS (US)

(21) Appl. No.: 18/574,630

(22) PCT Filed: Jun. 30, 2022
(86) PCT No.: PCT/US2022/035630

§ 371 Date: Dec. 27, 2023

Related U.S. Application Data
(60) Provisional application No. 63/216,666, filed on Jun. 30, 2021.

(51) Int. Cl. C08B 37/00; C08L 5/00

(52) U.S. Cl. CPC C08B 37/0087; C08B 37/0003; C08L 5/00

(57) ABSTRACT

Corn fiber gum (CFG) production via a path without a starch removal step, using sodium hydroxide during the extraction, eliminating the use of hydrogen peroxide throughout the process, and recovering CFG by spray drying is provided. Calcium hydroxide may also be used during the alkaline extraction to improve the color of the extracted CFG.

### RELATED APPLICATIONS

The present application claims the priority benefit of U.S. Provisional Patent Application Ser. No. 63/216,666, filed Jun. 30, 2021, entitled METHODS OF EXTRACTING CORN FIBER GUM AND USES IN EMULSION AND ENCAPSULATION, and is incorporated by reference herein in its entirety.

### BACKGROUND OF THE INVENTION

### Field of the Invention

In one or more embodiments, the present invention is directed toward economical methods of producing corn fiber gum (CFG) that has superior emulsion functionality over commercial grade gum arabic, at high yield, and involving fewer production steps. Starch is not removed from the corn (Zea mays) bran before CFG extraction thereby reducing production costs. Yet, the extracted CFG exhibits excellent emulsification properties.

### Description of the Prior Art

Corn bran is a co-product from corn milling processes. In dry corn milling, cleaned milled corn is fractionated into endosperm, germ, and corn bran. The endosperm, which contains high starch concentrations, is used for corn grits, meals, and flours, while the germ is harvested for oil, leaving the corn bran for uses as animal feed or corn germ cake. The wet milling of corn involves steeping of corn in a sulfur dioxide solution to soften corn kernels. Corn fiber is separated from the starch, gluten protein, and germ to produce corn gluten feed.

Corn bran or corn fiber is largely used as animal feed but has great potential to be used for human consumption. Corn bran is rich in fiber, protein, and other micronutrients and has been used in snacks and bakery foods. After the addition of corn bran, food product texture or quality (e.g. loaf volume of bread) may need to be improved.

The major component in corn bran is hemicellulose (38-57%), which mainly consists of arabinoxylan. The extraction of hemicellulose in corn bran, its composition, properties, and potential application as emulsifiers have been studied. Currently, many beverage products, such as juices, carbonated drinks, and alcoholic drinks, use gum arabic as an emulsifying agent. Gum arabic is a widely used natural emulsifier in those markets. Most other emulsifiers used in food products are synthetic compounds, such as Tween 80, mono-, diglycerides, etc. Chemically modified starches may be used to replace gum arabic but are not considered natural products. However, gum arabic is imported from Africa; its supply is not stable, and the quality is not consistent. Due to the rising demand for natural emulsifiers and the problems in obtaining consistently reliable high-quality gum arabic with a stable price, alternative emulsifiers are needed to replace gum arabic. The CFG extracted from corn bran has been studied for potential application as emulsifiers to replace gum arabic in delivering lipophilic nutrients. Studies have shown that the extraction of arabinoxylan from corn bran using alkaline agents produces CFG that has superior emulsifying stability than the commercial grade gum arabic. The presence of hydrophilic arabinoxylan molecules conjugated to hydrophobic protein chains in CFG allows the macromolecules to stabilize oil and water emulsions and thus, may give beverages a homogenous texture. However, in the previous studies, oil and starch were removed from corn bran prior to the alkaline extraction, of which the de-starching step added processing cost to the CFG production. In addition, hydrogen peroxide was used during the alkaline extraction or after the extraction to improve the color of CFG, while ethanol was used to precipitate CFG from the aqueous solution. All these chemical treatments result in additional processing cost to CFG production.

### SUMMARY OF THE INVENTION

According to one embodiment of the present invention, a method of making corn fiber gum from corn bran that has not undergone a starch removal step is provided. The method comprises extracting corn fiber gum from the corn bran by dispersing the corn bran in an alkaline, aqueous medium at a temperature of greater than 50° C. for a sufficient time to extract at least a portion of the corn fiber gum that is present within the corn bran. The dispersion is separated into a first solids fraction and a first liquid fraction. The pH of the first liquid fraction is subsequently adjusted to below 7 through the addition of an acid. The first liquid fraction is then separated into a second solids fraction and a second liquid fraction. The second liquid fraction is dried so the corn fiber gum product may be recovered.

According to another embodiment of the present invention, a method of making corn fiber gum from corn bran that has not undergone a starch removal step is provided. The method comprises extracting corn fiber gum from the corn bran by dispersing the corn bran in an alkaline, aqueous medium at a temperature of greater than 50° C. for a sufficient time to extract at least a portion of the corn fiber gum that is present within the corn bran. An amylase enzyme is added to the dispersion comprising the corn fiber gum, hydrolyzing at least a portion of the starch contained in the dispersion. The pH of the dispersion is adjusted to below 7 through the addition of an acid, and the dispersion is subsequently separated into a liquid fraction and a solid fraction. The liquid fraction is dried so the CFG product may be recovered.

According to still another embodiment of the present invention, a corn fiber gum product is provided. The corn fiber gum product comprises from about 2% to about 10% by weight soluble starch.

According to yet another embodiment of the present invention, a corn fiber gum product is provided. The corn fiber gum product comprises from about 2% to about 10% by weight soluble maltodextrins.

### BRIEF DESCRIPTION OF THE DRAWINGS

FIG. 1A is a flow chart of the overall extraction process of corn fiber gum (CFG) using a two-step NaOH extraction method without using α-amylase hydrolysis of starch after extraction of CFG;

FIG. 1B is a flow chart of the overall extraction process of CFG using a one-step extraction method and α-amylase hydrolysis of starch after extraction of CFG;

FIG. 2 is a microscope analysis of the starch contained in fraction 1 (see, FIG. 1A);

FIG. 3 is a graph of the emulsion studies of CFG, containing starch;

FIG. 4 is a graph of the typical particle size distributions of emulsion samples prepared using CFG (NaOH two-step extraction method) on day 0 and day 28, CFG (NaOH one-step extraction method) on day 0 and day 28, CFG (NaOH and Ca(OH)₂ one-step extraction method) on day 0 and day 28, and gum arabic on day 0 and day 7;

FIG. 5 is a graph of molecular weight distribution of CFGs extracted from de-oiled corn bran, as compared to gum arabic, as determined by GPC equipped with a RI detector; and

FIG. 6 is a graph of molecular weight distribution of CFG extracted from de-oiled corn bran, as compared to gum arabic, as determined by HPLC equipped with RI and UV detectors.

### DETAILED DESCRIPTION OF THE PREFERRED EMBODIMENT

Embodiments of the present invention are generally directed toward the use of corn bran for making corn fiber gum (CFG). Corn bran is a commonly used animal feed but has also shown other potential uses, such as for human consumption and as an emulsifier. Corn fiber gum can be obtained from corn bran. In certain embodiments of the present invention, CFG is extracted from corn bran that has optionally not been subjected to a starch removal process. According to certain embodiments of the present invention, CFG is extracted from the corn bran by being dispersed in an aqueous medium. Preferably, the aqueous medium is alkaline. Also, in certain embodiments the aqueous medium comprising the dispersion may be comprise a temperature of greater than 50° C., greater than 75° C., or greater than 100° C. At least a portion of the CFG contained in the corn bran is extracted, and extraction is followed by several steps. For example, in one or more embodiments, the extraction step may be followed by at least one pH-adjusting step, at least one separation step, and one drying step permitting recovery of the CFG product.

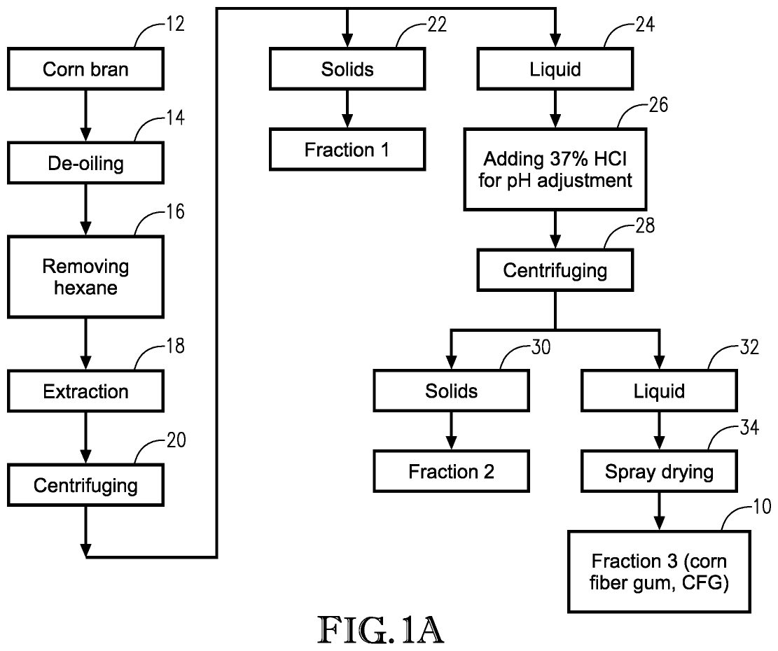

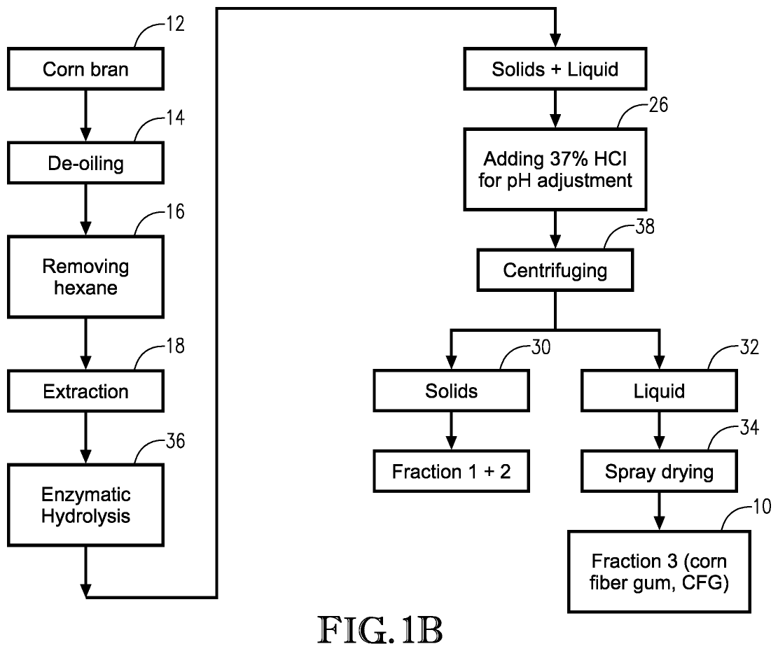

According to certain embodiments of the present invention, a method of making CFG from corn bran is provided and comprises, in part, two separation steps (see, FIG. 1A). As shown schematically in FIG. 1A, CFG 10 is extracted from the corn bran 12, and the corn bran 12 is then de-oiled. However, this de-oiling step 14 is optional, and not all embodiments need to include de-oiling the corn bran before extracting the CFG. In certain embodiments, a majority of the oil present within the corn bran is removed prior to the extraction of the CFG, and in at least one embodiment, substantially all of the oil present within the corn bran is removed prior to the extraction.

According to certain embodiments, the de-oiling step comprises extracting at least a portion of the oil from the corn bran using an organic solvent. In at least one embodiment, the organic solvent, containing the portion of corn oil removed from the corn bran, is removed prior to the CFG extracting step. In certain embodiments where the corn bran is de-oiled prior to the extraction step, the de-oiled CFG has an oil content of less than 1% by weight, or less than 0.5% by weight, or less than 0.1% by weight. In FIG. 1A, corn bran 12 is shown being de-oiled using hexane, one example of an appropriate organic solvent, which is removed in a solvent removal step 16 before extraction step 18 occurs.

After the corn bran is optionally de-oiled and the organic solvent is removed, CFG is extracted from the corn bran by dispersing the corn bran in an alkaline aqueous medium. In certain embodiments of the present invention, the alkaline, aqueous medium comprises NaOH and/or Ca(OH)₂. According to at least one embodiment, the alkaline, aqueous medium comprises NaOH as the only caustic agent. In certain embodiments, the alkaline, aqueous medium may comprise NaOH and Ca(OH)₂ present in a weight ratio of from about 1:4 to about 4:1, from about 1:2 to about 2:1, or about 1:1.

After extracting an amount of CFG from the corn bran, the dispersion containing an amount of extracted CFG is separated into a first solids fraction and a first liquid fraction. Then, the first liquid fraction is acidified through the addition of an acid, such as HCl. In other words, the pH of the first liquid fraction is adjusted to below 7. In certain embodiments, the pH is adjusted to below 6, or below 5. Even more preferably, the pH is adjusted to about 4.0 to about 4.5. Then, the first liquid fraction is separated into a second solids fraction and a second liquid fraction. In at least one embodiment of the present invention, at least one of the separating steps, and preferably both, comprises centrifuging the dispersion or the liquid fraction. However, it is within the scope of the present invention for other separation process, such as filtering and membrane separation, to be employed. As shown in FIG. 1A, after extraction 18, there is a first separation 20 that results in a first solids fraction 22 and a first liquid fraction 24. The pH of the first liquid fraction 24 is adjusted through acidifying step 26, and then the second separation step 28 occurs. In the embodiment of the present invention shown in FIG. 1A, both separation steps 20 and 28 are accomplished through centrifuging. Through separation step 28, first liquid fraction 24 is fractionated into second solids fraction 30 and second liquid fraction 32.

According to certain embodiments of the present invention, following the second separation step is a drying step wherein water is removed from the second liquid fraction. In more than one embodiment of the present invention, including as shown in FIG. 1A, the drying step 34 comprises spray drying the second liquid fraction 32, although other drying methods can also be used.

According to other embodiments of the present invention, a method of making CFG from corn bran is provided that comprises, in part, a separation step and an enzymatic hydrolysis step (see, FIG. 1B). As shown schematically in FIG. 1B, before CFG 10 is extracted from corn bran 12, the corn bran is de-oiled. However, this de-oiling step 14 is optional, and not all embodiments include de-oiling the corn bran before extracting the CFG. In certain embodiments, a majority of the oil present within the corn bran is removed prior to the extraction of the CFG, and in at least one embodiment, substantially all of the oil present within the corn bran is removed prior to the extraction.

According to certain embodiments, the de-oiling step comprises extracting at least a portion of the oil from the corn bran using an organic solvent. In at least one embodiment, the organic solvent, containing the portion of corn oil removed from the corn bran, is removed prior to the CFG extracting step. In certain embodiments where the corn bran is de-oiled prior to the extraction step, the de-oiled CFG has an oil content of less than 1% by weight, or less than 0.5% by weight, or less than 0.1% by weight. In FIG. 1B, corn bran 12 is shown being de-oiled using hexane, one example of an appropriate organic solvent, which is removed in step 16 before the extraction step 18 occurs.

After the corn bran is optionally de-oiled and the organic solvent removed, CFG is extracted from the corn bran by dispersing the corn bran in an alkaline aqueous medium. In certain embodiments of the present invention, the alkaline, aqueous medium comprises NaOH and/or Ca(OH)₂. According to at least one embodiment, the alkaline, aqueous medium comprises NaOH as the only caustic agent. In certain embodiments, the alkaline, aqueous medium may comprise NaOH and Ca(OH)₂ present in a weight ratio of from about 1:4 to about 4:1, from about 1:2 to about 2:1, or about 1:1.

According to certain embodiments of the present invention, after extracting an amount of CFG from the corn bran, at least a portion of the starch contained in the dispersion is hydrolyzed. This solubilizes at least a portion of the starch contained in the dispersion. As shown in FIG. 1B, enzymatic hydrolysis 36 may be performed. In certain embodiments of the present invention, an amylase enzyme, such as an alpha-amylase enzyme, is added to the dispersion comprising the CFG, and at least a portion of the starch contained in the dispersion is hydrolyzed. Other enzymes such as beta-amylase, glucoamylase, isoamylase, pullulanase may be used. According to at least one embodiment, at least a portion of the starch is hydrolyzed into soluble maltodextrin. Then, the dispersion is acidified through the addition of an acid, such as HCl. Preferably, the pH of the dispersion is adjusted to below 7, to below 6, or to below 5. Even more preferably, the pH is adjusted to about 4.0 to about 4.5. After the pH of the dispersion is adjusted, the dispersion is separated into a liquid fraction and a solids fraction using any technique known to those of skill in the art. In at least one embodiment of the present invention, the separating step 38 comprises centrifuging the dispersion.

According to certain embodiments of the present invention, following the separation step is a drying step wherein the second liquid fraction is dried. As shown in FIG. 1B, the drying step 34 comprises spray drying the second liquid fraction 32.

Other embodiments of the present invention are directed to CFG products that comprise varying amounts or relative concentrations of, for example, soluble starch. According to certain embodiments of the present invention, the CFG product is derived from de-oiled corn bran.

According to certain embodiments, the CFG product comprises from about 1% to about 10% by weight soluble starch. In at least one embodiment, the CFG product comprises from about 4% to about 7% by weight soluble starch.

In at least one embodiment of the present invention, the CFG product comprises from about 1% to about 10% by weight protein on a dry basis. In at least one embodiment, the CFG product comprises from about 2.5% to about 6% by weight protein on a dry basis.

Also, in certain embodiments of the present invention, the CFG product comprises from about 10% to about 50% by weight, from about 15% to about 40% by weight, or from about 20% to about 30% by weight arabinose on a dry basis.

In certain embodiments of the present invention, the CFG product comprises from about 2% to about 15% by weight, from about 4% to about 12% by weight, or about 6% to about 10% by weight galactose on a dry basis.

In certain embodiments of the present invention, the CFG product comprises from about 10% to about 60% by weight, from about 30% to about 50% by weight, or from about 35% to about 45% by weight xylose on a dry basis.

The monosaccharides described above are generally present in a bound form within the CFG. However, it is also within the scope of the present invention or at least some of the monosaccharide to be present in a free or unbound form.

In certain embodiments of the present invention, the CFG product comprises from about 1% to about 30% by weight, from about 7.5% to about 25% by weight, or from about 10% to about 20% by weight ash on a dry basis.

Other embodiments of the present invention are directed to CFG products that comprise varying amounts or relative concentrations of, for example, soluble maltodextrins. According to certain embodiments, the CFG product comprises from about 2% to about 10% by weight soluble maltodextrins. In at least one embodiment, the CFG product comprises from about 4% to about 7% by weight soluble maltodextrins.

According to yet another embodiment of the present invention, salt in extracted CFG is removed by dialysis or membrane separation before spray drying.

### EXAMPLES

The following examples set forth methods of extracting CFG that exhibit excellent emulsifying characteristics without first performing any starch removal from the corn bran. It is to be understood, however, that these examples are provided by way of illustration, and nothing therein should be taken as a limitation upon the overall scope of the invention.

### Materials

A corn bran sample from dry-milling was provided by Cargill Dry Corn Ingredients (Indianapolis, IN). Gum arabic was supplied by TIC Gums (Belcamp, MD). Orange oil was provided by Citrus and Allied Essences Ltd. (Lake Success, NY). The BAN 480 α-amylase was supplied by Novozymes (Davis, CA). Total starch assay kit was purchased from Megazyme International Ireland Ltd. (Wicklow, Ireland). Sodium hydroxide (NaOH), dimethyl sulfoxide (DMSO), hydrocholoric acid, and ethanol were all purchased from Thermo Fisher Scientific (Hudson, NH). All solvents were of HPLC grade.

### De-Oiling of Corn Bran

The corn bran sample was de-oiled using the method reported by Moreau et al. (1996). However, instead of using one stage oil extraction by hexane for an hour, the current study used five stages of oil extraction by hexane, each for 10-15 min. A 200 g ground corn bran was mixed with 400 mL hexane, agitated continuously for 10-15 min at room temperature, and sat for 1 min to allow phase separation. The top hexane-rich phase was decanted, followed up the addition of 400 mL hexane to repeat the de-oiling process. A total of five hexane de-oiling cycles were conducted for a total hexane consumption of 2000 mL. The de-oiled corn bran was dried in an oven at 40° C. for 48-72 hours to remove the hexane.

### Extraction of Corn Fiber Gum

The de-oiled corn bran was extracted using a Parr reactor (Parr Instrument Company, Moline, IL) at 120° C. for 60 min.

For the two-step extraction method without using a-amylase to hydrolyze starch, 30 g defatted corn bran (in wet basis) and 2.40 g anhydrous NaOH was added into 600-mL water prior to the extraction process. After the extraction, the mixture was centrifuged at 5,520 g for 10 min to separate the solids fraction (fraction 1) from the liquid fraction (mainly hemicellulose). 200-mL of water was added to the Parr reactor to recover residual extracted mixture and wash the decanted solids. The hemicellulose-rich liquid fraction was adjusted to pH 4.0-4.5 with the addition of 37% hydrochloric acid (HCl), and stirred continuously overnight, before being centrifuged at 15,300 g for 20 min to separate into solids (fraction 2) and liquid. The remaining liquid fraction was filtered through a 10-μm cellulose filter (Thermo Fisher Scientific Inc., Waltham, MA), dried using a Mini Spray Dryer B-290 (Buchi Corporation, New Castle, DE), and collected as Fraction 3 or Corn Fiber Gum (CFG). The spray dryer was setup at 5 mL/min sample feed rate, and inlet temperature of 130° C. The CFG-extraction process is summarized in FIG. 1A.

For the one-step extraction procedure using NaOH, the extracting liquid after the alkaline extraction was adjusted to pH 5.8-6.5 using 37% HCl and heated to 70° C. Enzymatic hydrolysis was conducted by adding 0.02 mL of BAN 480 α-amylase into the liquid. The mixture was agitated continuously for 2 h. After the enzymatic hydrolysis, the pH of the liquid was then adjusted to 4.0-4.5 with the addition of 37% hydrochloric acid (HCl), and stirred continuously for overnight, before being centrifuged at 15,300 g for 20 min. The liquid fraction was dried using a spray dryer and collected as Fraction 3. The CFG-extraction process using NaOH only for one-step separation is summarized in FIG. 1B.

For the extraction method using the mixture of NaOH and Ca(OH)₂, 1.2 g of NaOH and 1.11 g of Ca(OH)₂ was added to the extracting liquid during the alkaline extraction, instead of using 2.4 g of NaOH in the NaOH only extraction. The CFG-extraction process using the mixture of NaOH and Ca(OH)₂ for the one-step separation is summarized in FIG. 1B.

### Emulsion Study

The stock solution was prepared by adding 1.2 g sodium benzoate and 3.6 g citric acid to 1000 mL water and stirred for 1 h on a stir plate. Each gum sample (gum arabic or CFG, 5 g) was added into a 60 mL stock solution. The mixture was stirred continuously on stir plates for 12-18 h to produce homogenous solution. Orange oil (10 g) was then added to the gum-containing solution. The mixture was then agitated by a hand-held homogenizer (BioSpec Inc., Bartlesville, OK) at high speed for 30 s, followed by a laboratory benchtop homogenizer (Pro Scientific Inc., Oxford, CT) at 30,000 rpm homogenization for 2 min, and lastly homogenization by a microfluidizer (M110P 30-UL, Microfluidics, Newton, MA) at 20,000 psi for three passes. The quality of the emulsion was determined using a laser scattering instrument (LA910, Horiba Inc., Irvine, CA). Commercial grade gum Arabic was used as emulsifier for comparison purpose.

### Microscopic Images

Ground CFG fraction 1 (0.1 g) was dispersed onto a microscope slide. A few drops of iodine solution was added to the sample, covered with the cover slip, and visualized with a BX51 microscope (Olympus America, Melville, NY). Images and photographs were captured using a 40× objective, a Spot Insight camera, and Spot 4.6 Windows software (Diagnostic Instrument, Sterling Heights, MI).

### Color Parameters

Samples of CFG were subjected to color analysis using a Minolta CR-300 Chroma Meter (Konica Minolta Sensing Americas, Inc., Ramsey, NJ). The degree of lightness (L) values obtained from the analysis was used as the determination of whiteness for the samples, with a value of 100 indicates white, while 0 value indicates dark. The instrument was calibrated against a standard white reference plate.

### Composition Analysis

The moisture content was determined by American Association of Cereal Chemists (AACC) 44-19 method (American Association of Cereal Chemists. Approved Methods Committee, 2000). Protein analysis was conducted according to Association of Official Agricultural Chemists (AOAC) 990.03 method. Protein contents were obtained by multiplying nitrogen values with a factor of 6.25. Crude fat, ash, and starch analysis were conducted according to the AOAC 920.39 method, AOAC 942.05 method, and AOAC 996.11 method, respectively. The hemicellulose and cellulose content were determined according to the procedure of Kang et al. (2011). Cellulose and hemicellulose concentrations in the samples were determined using a high performance anion-exchange column (HPAEC) connected to a pulsed amperometric detector (PAD). The HPAEC-PAD system was an ICS-3000 Ion Chromatography System (Dionex Corporation, Sunnyvale, CA) equipped with a 3×250 mm-CarboPac PAI analytical column, and 3×50-mm CarboPac PAI guard column (Dionex Corp). The HPAEC-PAD system was controlled using Chromeleon software (Dionex Corp). The analytical method was adopted from Dionex Technical Notes 20 (Dionex Corporation, 2004). Mobile phase was 15 mM NaOH; the flow rate was 1 mL/min at ambient temperature (ca. 25° C.). Quantification of sample was based on the integrated peak of sample relative to the area of the known quantity of standard glucose, xylose, arabinose, and galactose.

### GPC Analysis

Gel permeation chromatography (GPC) was used to determine the molecular weight distribution of compounds. Gum samples were dissolved in DMSO solvent at 2 mg/mL concentration, filtered and injected into a PL-GPC 220 system (Polymer Laboratories Inc., Amherst, MA) equipped with three Phenogel columns (00H-0642-KO, 00H-0644-K0, 00H-0646-KO, Phenomenex Inc., Torrance, CA), and a refractive index (RI) detector, operating at 0.8 mL/min flow rate at 80° C.

### High Performance Liquid Chromatography (HPLC) Analysis

The molecular weight distribution of CFG samples and gum arabic were also determined with a HPLC system Agilent 1100 Series (Agilent, Waldbronn, Germany) consisted of a G1311A pump, an automatic injector with a 10 μL loop, and a G1315A DAD equipped with a workstation computer. The HPLC system was connected to a Viscotek refractive index detector, Viscotek 270-08 dual detector, OmniSEC triple detection/light scattering detector, and OmniSEC software (Malvern Instruments Inc., Westborough, MA) and equipped with two PSS Suprema Analytical GPC columns (sua0830101e2, sua0830103e2, Polymer Standards Service-USA, Inc., Amherst MA) connected in series. The mobile phase in the column was 5 mM NaNO₃ in water, at a flow rate of 1.0 mL/min at ambient temperature and the UV detection wavelength was set at 280 nm. Concentrations were determined from the peak area.

### Statistical Analysis

All reported data are an average of at least two data with standard deviation. The yield of each fraction extracted from corn bran was calculated from three individual experiments. The comparison of means was performed using Excel t-test, with p value at 0.05 significance level.

### RESULTS AND DISCUSSION

### Composition and De-Oiling of Corn Bran

Hemicellulose, which comprised arabinose, galactose, and xylose, was the main composition in the de-oiled corn bran at 56.2%. The remaining composition in the de-oiled corn bran was protein (4.6%), ash (0.3%), cellulose (33.9%), and starch (7.6%). As shown from the composition analysis, corn bran consisted of high concentration of hemicellulose and protein, both of which are the important ingredient for the emulsifier. Starch was commonly removed prior to the CFG extraction (Doner et al., 1997; Doner et al., 1998; McPherson et al., 2006; Doner et al., 2000). The removal of starch and the subsequent recovery using ethanol resulted in cost ineffective process for the industrial scale production. Therefore, current study eliminated the starch removal steps, with the additional intention to recover starch in the CFG fraction, and thus increase the yield of CFG.

In these examples, the oil in the corn bran was removed using the method conducted by Moreau et al. (1996) with two modifications. Moreau et al. (1996) added 0.01% of butylated hydroxytoluene (BHT) into hexane during the oil extraction to prevent the oxidation of oil. Secondly, the oil extraction was conducted in one step by agitating 10 mL hexane with 1 g corn bran at 25° C. for 1 h. The current study did not add BHT into hexane because the extracted oil was not used in any subsequent analysis, while the oil extraction process was conducted in five sequential steps, each started with adding 2 mL hexane to 1 g corn bran, agitating for 12 min, followed by decanting the hexane for oil removal.

An alternative oil extraction method using ethanol reported by Xu et al. (2009) was also explored in the current study. The de-oiling was conducted using a Soxhlet apparatus until the extracted liquid was colorless. However, the small amount of de-oiled sample produced in each batch of experiment was deemed not practical for large scale de-oiled samples, and thus were not pursued further.

### Extraction of CFG From Corn Bran

For the two-step extraction, 40.6% of CFG was recovered from the de-oiled corn bran, as shown in Table I. The yields of one-step extraction of CFG using NaOH and the mixture of Ca(OH)₂ and NaOH was 45.7 and 42.4%, respectively, an increase in CFG yield over the two-steps method.

TABLE I
The yields and brightness of corn fiber gum (CFG) extracted by different methods.

| | NaOH extraction + | NaOH and Ca(OH)₂ + | NaOH extraction, | |
|---|---|---|---|---|
| | α-amylase | α-amylase | No α-amylase | |
| | hydrolysis | hydrolysis | hydrolysis | Gum Arabic |
| Yield (Average) | 45.72 ± 1.74 a | 42.38 ± 2.19 a | 40.58 ± 3.10 a | |
| Color (average) | 70.81 ± 1.09 b | 80.68 ± 0.67 c | 69.28 ± 0.58 b | 85.53 ± 0.29 d |

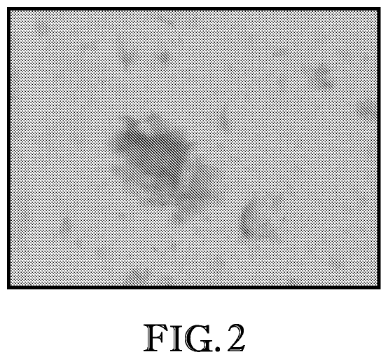

In the two-step extraction method, there was less than 2% yield of fraction 2 during the recovery. Moreover, starch that was present in the corn bran formed a film layer in fraction 1, preventing the recovery of starch into the CFG fraction. A microscope analysis of fraction 1 indicated that the starch was gelatinized, but not completely soluble in the liquid, as reflected by the fraction 1 sample turning purple in the presence of iodine, without signs of birefringence (see, FIG. 2). Therefore, the use of one-step extraction method was intended to partially hydrolyze the gelatinized starch using α-amylase, rendering the hydrolyzed starch more water soluble.

In comparison to other CFG extraction methods that involved the use of hydrogen peroxide in the two-step extraction method, the CFG yield from the de-starched corn bran was 39% (Yadav, et al., 2010), which is comparable to the CFG yield in the current study, which utilized corn bran without starch removal. However, the CFG recovery in other study was through the use of ethanol precipitation, which will be costly if implemented in a large industrial scale, as compared to the use of spray dryer for CFG recovery in current study, which is more in line with the industrial practices.

In many previous studies, hydrogen peroxide was added to the alkaline mixture during the extraction of CFG from corn bran (Yadav, et al., 2009; Yadav, et al., 2012; Yadav, et al., 2011; Doner, et al., 2001; Kokubun et al., 2014) to improve the yield of CFG (Yadav, et al., 2010). However, as a consequence of hydrogen peroxide addition, starch has to be removed from the corn bran prior to the alkaline extraction to prevent the oxidation of starch. In the current study, the presence of starch in the alkaline and hydrogen peroxide extraction resulted in dark color of the corn bran that can become undesirable for use as emulsifiers. Thus, current study extracted CFG without the use of hydrogen peroxide for the com bran.

### Color Parameters

As compared to gum arabic with an L value of 85, CFG extracted using NaOH had lower average L value at 70, indicating less brightness in the NaOH-extracted CFG. However, the use of Ca(OH)₂ in the extraction whitened the color of CFG, resulted in an improved L value of 81.

### Composition of CFG from Corn Bran

The composition of the extracted CFG was analyzed and is summarized in Table II. Compared to the composition in corn bran, all CFG fractions had higher ash concentrations, ranged from 13.9 to 16.8%, as compared to 0.3% ash in the corn bran. The increase in the ash content was attributed to the addition of alkaline and acid during the extraction process, resulted in the salt formation, which became the ash in CFG fractions. In addition, all the CFG fractions had higher hemicellulose content than that of corn bran. Hemicellulose, which is soluble in alkaline solution, was concentrated in the CFG fractions. Cellulose concentration, on the other hand, was lower in the CFG fractions than that in the corn bran, because cellulose is not alkaline soluble, and was thus removed during the extraction process through fractions 1 and 2.

TABLE II
The composition of corn fiber gum (CFG)
extracted by different methods.

| | 1 Step, NaOH and | 2 Steps, NaOH, |
|---|---|---|
| | Ca(OH)₂ + α-amylase | No α-amylase |
| | hydrolysis | hydrolysis |
| Ash | 13.90 ± 0.83 | 16.78 ± 0.21 |
| Protein | 3.49 ± 0.47 | 6.25 ± 0.45 |
| Arabinose | 25.49 ± 1.61 | 26.57 ± 1.56 |
| Galactose | 8.11 ± 0.59 | 8.36 ± 0.48 |
| Xylose | 36.36 ± 2.56 | 37.24 ± 2.35 |
| Total glucose | 19.33 ± 1.47 | 3.30 ± 0.56 |
| Starch | 6.60 ± 0.12 | 0.33 ± 0.08 |
| Total= | 106.68% | 98.51% |

Among the three CFG fractions, both the CFGs extracted from the one-step extraction method, which involved the enzymatic hydrolysis using alpha-amylase, resulted in higher starch recovery in the CFG. The starch content was 4.7 and 6.6%, respectively, for the CFG extracted from NaOH and the combination of NaOH and Ca(OH)₂, both of which were higher than the CFG from the two-steps extraction method, at 0.33%. The increase in the starch recovery in the one-step extraction method can be credited for the higher yields in the resulting CFGs.

In addition, the extraction method involving the use of Ca(OH)₂ resulted in lower protein content in the CFG, as shown by 3.5% protein for the CFG extracted using the combination of NaOH and Ca(OH)₂, as compared to 5.4 and 6.3%, respectively, for the extraction using NaOH in two-steps and one-step extraction methods. The lower protein content in the CFG can be attributed to the extraction condition used in the NaOH/Ca(OH)₂ combination. Although the alkalinity is the same at 2 meq alkalinity per 1 g corn bran for both the NaOH treatment and the treatment combining NaOH and Ca(OH)₂, the average pH of the liquor after the extraction was 10.3 for the NaOH only treatment, as compared to 9.6 for the NaOH/Ca(OH)₂ treatment. The lower pH for the NaOH/Ca(OH)₂ treatment might be responsible for lower concentration of protein being extracted into the CFG fraction. In addition, the lower protein content might be responsible for the lighter color in the NaOH/Ca(OH)₂-extracted CFG. The milder extraction condition in NaOH/Ca(OH)₂ extraction might have reduced the extraction of the color pigment and corn protein from the corn bran, and thus resulted in the whiter CFG color.

The effects of the level of α-amylase on recovery of starch were examined in this study. The addition of 0.02 mL (20 μL) BAN 480 α-amylase for a hydrolysis of 2 h was determined to provide higher starch concentration atα4.7%, as compared to the use of 0.0002 mL (0.2 μL) resulted in 1.7% starch, even though the starch recovery was markedly higher than the 0.3% starch in the CFG extracted without using α-amylase.

### Functional Properties of CFG-Emulsion

The extracted CFGs were subjected to the emulsion test. The emulsion samples were prepared using oil-to-sample ratio of 2 using orange oil, as described by Yadav et al. (2010). The particle size of emulsion was recorded on day 0, 1, 7, 14, 21 and 28. The particle size of gum arabic, as compared to CFG, was measured using laser scattering instrument.

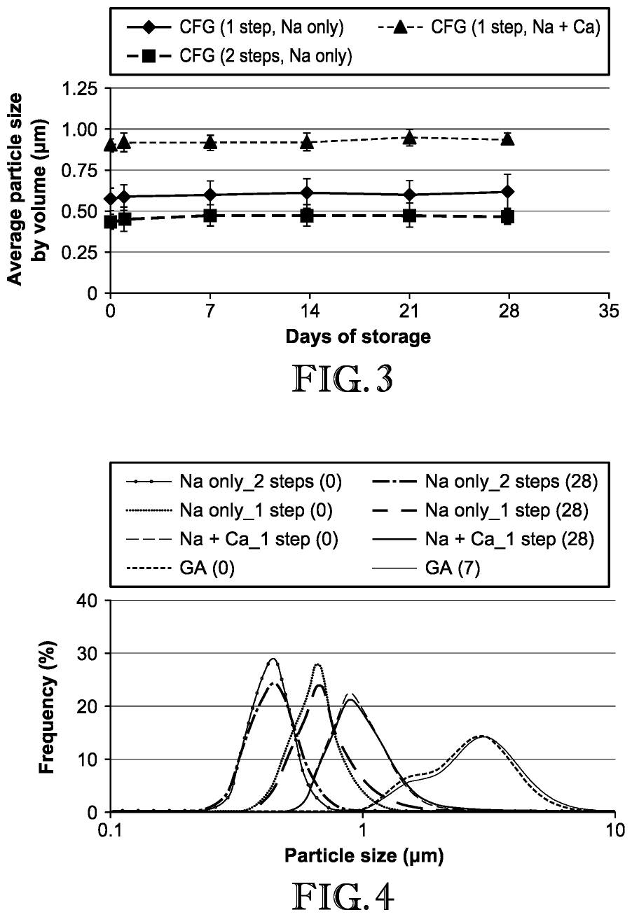

On day 0, the average emulsion size of the gum arabic emulsion was 2.74 μm, which was significantly greater than the emulsion samples prepared using CFGs, at 0.57, 0.90, and 0.43 μm, for one-step NaOH-extracted CFG, one-step NaOH/Ca(OH)₂-extracted CFG, and two-steps NaOH-extracted CFG, respectively, as shown in FIG. 3. Furthermore, the emulsion sample prepared using gum arabic became unstable within 1 day, as reflected by the presence of two peak distribution of emulsion size of gum arabic on day 0 (FIG. 4). The gum arabic-stabilized emulsion samples deteriorated over time, resulting in the average emulsion particle size of 4.54 μm after two weeks. In comparison, all the emulsion samples stabilized by CFGs were relatively stable. The average emulsion droplet size of samples stabilized by one-step NaOH-extracted CFG, one-step NaOH/Ca(OH)₂-extracted CFG, and two-steps NaOH-extracted CFG were 0.62, 0.94, and 0.47 μm, respectively, 28 days after homogenization. More importantly, all the distribution of emulsion droplet capacity vs size of the CFG-stabilized samples remained as single peak, indicating that the emulsion samples were stable. However, visual inspection of the emulsion samples revealed that the samples stabilized using one-step NaOH/Ca(OH)₂-extracted CFG exhibited some oil ring at the surface of the sample, suggesting that the gravitational separation of oil phase resulted in creaming on the sample. Therefore, even though whiter in color, the one-step NaOH/Ca(OH)₂-extracted CFG had partially lost its emulsion functionality. By contrast, the CFG extracted using NaOH only was considered more suitable for commercial applications. Lower average emulsion droplet size of the CFG extracted using two-step method as compared to that of one-step method indicated that the emulsion samples were more stable. Higher starch content in the one-step method might reduce the level CFG for the emulsion, and thus resulted in higher average emulsion droplet size of the emulsion samples.

Although the CFG samples contained a higher concentration of NaCl salt, resulted from the neutralization of NaOH and HCl, as reflected by higher ash concentration, the emulsions prepared with CFG remained superior to the emulsions with gum arabic. The current study showed that the CFG emulsion, in the presence of 17% NaCl-dominant ash concentration, remained superior to gum arabic emulsions.

### Molecular Weight Determination

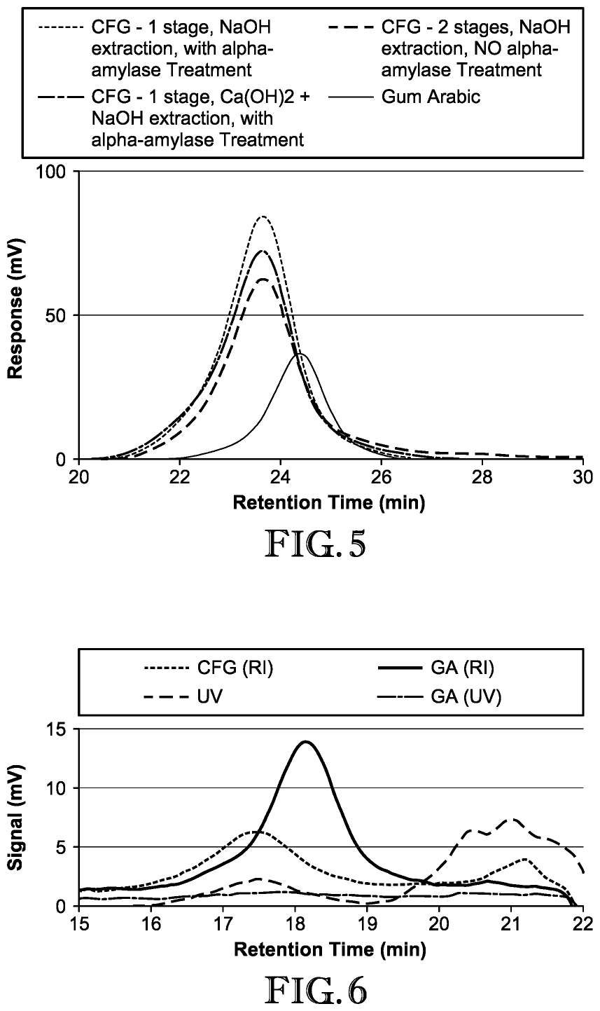

The molecular weight of CFG samples were determined using both GPC and HPLC. From the GPC analysis, all three CFG samples exhibited overlapping peaks (FIG. 5), indicating that the compounds have similar molecular weight. More importantly, the GPC analysis provided the evidence that the different CFG extraction methods did not result in CFG degradation. Compared to gum arabic, CFG samples were eluted at earlier retention times, indicating that CFG samples had larger hydrodynamic volume.

HPLC analysis was applied on two samples: two-step NaOH-extracted CFG and gum arabic. From the HPLC analysis, as shown in Table III, gum arabic had larger molecular weight (411 kDa), but smaller hydrodynamic radius (10 nm), indicating that the molecules were more compact. In comparison, CFG had smaller molecular weight (294 kDa), but almost twice larger hydrodynamic radius (18 nm). The less compact structure of CFG contributed to its higher intrinsic viscosity at 1.43 dl/g vs. 0.18 dl/g for gum arabic. The higher viscosity in CFG samples might have improved the emulsion stability of the samples by slowing the separation of emulsion particles sizes and creating higher drag forces on the emulsion.

TABLE III
Comparison of molecular weight of corn fiber gum (CFG) from
corn bran and gum arabic using HPLC equipped with RI, UV,
Intrinsic Viscosity and Light Scattering Detectors.

| | CFG | Gum Arabic |
|---|---|---|
| Mn - (Daltons) | 185,463 | 217,020 |
| Mw - (Daltons) | 293,997 | 411,139 |
| Mz - (Daltons) | 548,750 | 778,981 |
| Mp - (Daltons) | 196,768 | 277,821 |
| Intrinsic viscosity - (dl/g) | 1.4318 | 0.1805 |
| Hydrodynamic radius - (nm) | 17.87 | 9.92 |

From the HPLC results in FIG. 6, the CFG sample had a stronger UV signal, indicating a higher concentration of protein (4.9%) in the CFG samples. The extracted CFG showed a distribution of two molecular weights, with the lower molecular weight fraction bearing higher protein amount. In comparison, the gum arabic had a lower UV signal, because of the lower protein content (3.0%). The higher protein concentration in CFG might contribute to the better emulsion performance of CFG as compared to gum arabic.

### CONCLUSION

Corn fiber gum (CFG) was extracted from corn bran without starch removal, using NaOH, or a mixture of NaOH and Ca(OH)₂. The use of Ca(OH)₂ during the extraction process resulted in whiter color of CFG. Starch that was present in corn bran was gelatinized during the alkaline extraction, and formed a film layer preventing the starch from dissolving in the CFG fraction during the subsequent separation. The hydrolysis of starch by alpha-amylase after the alkaline extraction improved the starch recovery, as well as the yields of CFG. The elimination of starch removal step in CFG production prior to the alkaline extraction still resulted in CFG capable of forming a stable emulsion. More importantly, the simplified process would lower the production cost through the elimination of costly starch removal step.

### REFERENCES

1. American Association of Cereal Chemists. Approved Methods Committee. (2000). Approved Methods of the American Association of Cereal Chemists.
2. Dionex Corporation. (2004). Technical Note 20: Analysis of Carbohydrates by High-Performance Anion-Exchange Chromatography with Pulsed Amperometric Detection (HPAE-PAD).
3. Doner, L. W., Chau, H. K., Fishman, M. L., & Hicks, K. B. (1998). An improved process for isolation of corn fiber gum. Cereal Chemistry, 75 (4), 408-411.
4. Doner, L. W. & Hicks, K. B. (1997). Isolation of hemicellulose from corn fiber by alkaline hydrogen peroxide extraction. Cereal Chemistry, 74 (2), 176-181.
5. Doner, L. W. & Johnston, D. B. (2001). Isolation and characterization of cellulose/arabinoxylan residual mixtures from corn fiber gum processes. Cereal Chemistry, 78 (2), 200-204.
6. Doner, L. W., G. A. Sweeney, & K. B. Hicks. (2000). U.S. Pat. No. 6,147,206: Isolation of hemicellulose from corn fiber. Isolation of Hemicellulose from Corn Fiber
7. E, X. (2010). Hemicellulose fiber gum from distillers grain: isolation, structure and properties. MS Thesis, Kansas State University, Manhattan, KS.
8. Kang, J., Cui, S. W., Phillips, G. O., Chen, J., Guo, Q., & Wang, Q. (2011). New studies on gum ghatti (Anogeissus latifolia) part II. Structure characterization of an arabinogalactan from the gum by 1D, 2D NMR spectroscopy and methylation analysis. Food Hydrocolloids, 25(8), 1991-1998.
9. Laurikainen, T., Härkönen, H., Autio, K., & Poutanen, K. (1998). Effects of enzymes in fibre-enriched baking. Journal of the Science of Food and Agriculture, 76 (2), 239-249.
10. McPherson, R., Scott, J., & Underwood, J. (2006). U.S. Pat. No. 20,060,029702 A1: Continuous aqueous process for the isolation of hemicellulose from corn hulls and other plant hulls.
11. Mendonca, S., Grossmann, M., & Verhé, R. (2000). Corn bran as a fibre source in expanded snacks. LWT-Food Science and Technology, 33 (1), 2-8.
12. Moreau, R. A., Johnston, D. B., & Hicks, K. B. (2007). A comparison of the levels of lutein and zeaxanthin in corn germ oil, corn fiber oil and corn kernel oil. Journal of the American Oil Chemists' Society, 84 (11), 1039-1044.
13. Moreau, R. A., Powell, M. J., & Hicks, K. B. (1996). Extraction and quantitative analysis of oil from commercial corn fiber. Journal of Agricultural and Food Chemistry, 44 (8), 2149-2154.
14. Moros, E., Darnoko, D., Cheryan, M., Perkins, E., & Jerrell, J. (2002). Analysis of xanthophylls in corn by HPLC. Journal of Agricultural and Food Chemistry, 50(21), 5787-5790.
15. Perry, A., Rasmussen, H., & Johnson, E. J. (2009). Xanthophyll (lutein, zeaxanthin) content in fruits, vegetables and corn and egg products. Journal of Food Composition and Analysis, 22 (1), 9-15.
16. Qian, C., Decker, E. A., Xiao, H., & McClements, D. J. (2011). Comparison of biopolymer emulsifier performance in formation and stabilization of orange oil-in-water emulsions. Journal of the American Oil Chemists' Society, 88 (1), 47-55.
17. Rose, D. J., Inglett, G. E., & Liu, S. X. (2010). Utilisation of corn (Zea mays) bran and corn fiber in the production of food components. Journal of the Science of Food and Agriculture, 90 (6), 915-924.
18. Shah, A. R., Shah, R., & Madamwar, D. (2006). Improvement of the quality of whole wheat bread by supplementation of xylanase from Aspergillus foetidus. Bioresource Technology, 97(16), 2047-2053.
19. Williams, P. & Phillips, G. (2009). Gum arabic. Handbook of Hydrocolloids, 252-273.
20. Xu, W., Reddy, N., & Yang, Y. (2009). Extraction, characterization and potential applications of cellulose in corn kernels and Distillers' dried grains with solubles (DDGS). Carbohydrate Polymers, 76 (4), 521-527.
21. Yadav, M. P., Cooke, P., Johnston, D. B., & Hicks, K. B. (2010). Importance of protein-rich components in emulsifying properties of corn fiber gum. Cereal Chemistry, 87 (2), 89-94.
22. Yadav, M. P., Johnston, D. B., & Hicks, K. B. (2009). Corn fiber gum: New structure/function relationships for this potential beverage flavor stabilizer. Food Hydrocolloids, 23(6), 1488-1493.
23. Yadav, M. P., Johnston, D. B. Hotchkiss Jr, A. T., & Hicks, K. B. (2007). Corn fiber gum: a potential gum arabic replacer for beverage flavor emulsification. Food Hydrocolloids, 21(7), 1022-1030.

24. Yadav, M. P., Moreau, R. A., Hotchkiss, A. T., & Hicks, K. B. (2012). A new corn fiber gum polysaccharide isolation process that preserves functional components. Carbohydrate Polymers, 87(2), 1169-1175.
25. Yadav, M. P., Nuñez, A., & Hicks, K. B. (2011). Isolation, Purification, and Identification of Protein Associated with Corn Fiber Gum. Journal of Agricultural and Food Chemistry, 59(24), 13289-13294.
26. Yadav, M. P., Parris, N., Johnston, D. B., & Hicks, K. B. (2008). Fractionation, characterization, and study of the emulsifying properties of corn fiber gum. Journal of Agricultural and Food Chemistry, 56(11), 4181-4187.
27. Yadav, M. P., Parris, N., Johnston, D. B., Onwulata, C. I., & Hicks, K. B. (2010). Corn fiber gum and milk protein conjugates with improved emulsion stability. Carbohydrate Polymers, 81(2), 476-483.
28. Yadav, M., Moreau, R., & Hick, K. (2012). Production of corn fiber gum under conditions that retain its functional components. Gums and Stabilisers for the Food Industry 16, 335, 59.

1. A method of making corn fiber gum from corn bran comprising:
extracting corn fiber gum from the corn bran by dispersing the corn bran in an alkaline, aqueous medium at a temperature of greater than 50° C. for a sufficient time to extract at least a portion of the corn fiber gum that is present within the corn bran;
separating the dispersion into a first solids fraction and a first liquid fraction;
adjusting the pH of the first liquid fraction to below 7 through the addition of an acid;
separating the first liquid fraction into a second solids fraction and a second liquid fraction;
drying the second liquid fraction to recover the corn fiber gum,
wherein the extracting step occurs using corn bran that has not undergone a starch removal step.

2. A method of making corn fiber gum from corn bran comprising:
extracting corn fiber gum from the corn bran by dispersing the corn bran in an alkaline, aqueous medium at a temperature of greater than 50° C. for a sufficient time to extract at least a portion of the corn fiber gum that is present within the corn bran;
adding an amylase enzyme to the dispersion comprising the corn fiber gum and hydrolyzing at least a portion of the starch contained in the dispersion;
adjusting the pH of the dispersion to below 7 through the addition of an acid;
separating the dispersion into a liquid fraction and a solids fraction; and
drying the liquid fraction to recover the corn fiber gum,
wherein the extracting step occurs using corn bran that has not undergone a starch removal step.

3. The method of claim 2, wherein the corn bran is de-oiled prior to the extracting step.

4. The method of claim 3, wherein the de-oiling step comprises extracting at least a portion of the oil from the corn bran using an organic solvent, such as hexane.

5. The method of claim 4, wherein the de-oiled corn bran is dried prior to the corn fiber gum extracting step to remove the organic solvent.

6. The method of claim 2, wherein the alkaline, aqueous medium comprises NaOH and/or Ca(OH)₂.

7. The method of claim 6, wherein the alkaline, aqueous medium comprises NaOH as the only caustic agent.

8. The method of claim 6, wherein the alkaline, aqueous medium comprises NaOH and Ca(OH)₂ present in a weight ratio of from about 1:4 to about 4:1.

9. The method of claim 2, wherein the drying step comprises spray drying the liquid fraction.

10. The method of claim 2, wherein the separating step(s) comprise centrifuging dispersion or liquid fraction.

11. A corn fiber gum product comprising from about 2% to about 10% by weight soluble starch.

12. A corn fiber gum product comprising from about 2% to about 10% by weight soluble maltodextrins.

13. The corn fiber gum product of claim 11, wherein the product is derived from de-oiled corn bran.

14. The corn fiber gum product of claim 11, wherein the product comprises from about 1% to about 10% by weight protein on a dry basis.

15. The corn fiber gum product of claim 11, wherein the product comprises from about 10% to about 50% by weight arabinose on a dry basis.

16. The corn fiber gum product of claim 11, wherein the product comprises from about 2% to about 15% by weight galactose on a dry basis.

17. The corn fiber gum product of claim 11, wherein the product comprises from about 10% to about 60% by weight xylose on a dry basis.

18. The corn fiber gum product of claim 11, wherein the product comprises from about 1% to about 30% by weight ash on a dry basis.
